(19) United States
(12) Patent Application Publication
(10) Pub. No.: US 2026/0327819 A1
(43) Pub. Date: Oct. 22, 2026

(54) COMBINATION SYSTEM AND METHOD FOR OPERATING A COMBINATION SYSTEM

(71) Applicant: Siemens Energy Global GmbH & Co. KG, München (DE)

(72) Inventors: Suhel Ahmad, Duisburg (DE); Peter Adam, Nürnberg (DE); Lukas Biyikli, Ratingen (DE)

(21) Appl. No.: 19/112,309

(22) PCT Filed: Sep. 5, 2023
(86) PCT No.: PCT/EP2023/074312

§ 371 Date: Mar. 17, 2025

(30) Foreign Application Priority Data
Sep. 30, 2022 (DE) 10 2022 210 397.1

(51) Int. Cl. C25B 9/67; B01D 53/00; C25B 1/04; F01D 15/10; F01K 11/00; F22B 1/16; F25B 29/00

(52) U.S. Cl. CPC C25B 9/67; B01D 53/00; C25B 1/04; F01D 15/10; F01K 11/00; F25B 29/003; B01D 2257/504; B01D 2259/65; F05D 2220/76; F22B 1/16

(57) ABSTRACT

The invention relates to a system having a heat pump circuit with a refrigerant evaporator, designed for evaporating a refrigerant, and a compressor, designed for compressing the refrigerant. The compressor is connected in terms of flow to the refrigerant evaporator, furthermore comprising a refrigerant condenser, designed for condensing the refrigerant. The refrigerant condenser is connected in terms of flow to the compressor. The system also includes a restrictor device, designed for reducing the temperature and the pressure of the refrigerant. The restrictor device is connected to the refrigerant condenser. The refrigerant evaporator is connected in terms of flow to the restrictor device. The system also includes a heat generation system having a cooling circuit with a cooling medium. The heat generation system is designed in such a way that, during the operation, the cooling medium can be heated.

### BACKGROUND

Green hydrogen produced by electrolysis is considered to be an important factor in reaching worldwide decarbonization targets because the whole value chain from production to transport to conversion into heat or electrical energy can be carbon-free. In an electrolysis process, electrical, preferably so-called green energy from the wind, sun, or water is used to split a water molecule into hydrogen (H₂) and oxygen (O₂). However, in this process only approximately 75% of the supplied electrical energy is converted into hydrogen (H₂) and the remaining 25% is converted into heat.

For this reason, the electrolysis must be cooled. This can be particularly challenging when the electrolysis is performed in regions with high ambient temperatures, for example in the desert, because a corresponding amount of cooling water at a specific temperature is required. The lack of availability of cooling water could present a risk to the operation of the electrolysis because the cooling is essential for the operation of the system.

In addition to the large-scale production of green hydrogen, direct air capture (DAC) is also considered to be an important factor in reaching decarbonization targets because negative emissions can be generated. According to the net zero emission scenario of the International Energy Agency (IEA), the need for direct air capture will rise to 1 gigaton of carbon dioxide (CO₂) per year in order to achieve climate neutrality by 2050. Because of the relatively low concentration of carbon dioxide (CO₂) in the ambient air of on average 400 ppm, however, DAC has a very high specific heat energy requirement per ton of carbon dioxide (CO₂) captured. In the worst case, fossil fuels have to be burned in order to provide the energy which results in additional carbon dioxide (CO₂) emissions.

The production of green hydrogen on a large scale is a challenge. Most systems for generating green hydrogen are planned and operated at a pilot scale in the vicinity of the hydrogen consumer because large-scale infrastructure for transporting hydrogen generally does not yet exist. The consumers are, for example, industrial customers who usually have cooling water at the required temperature available. Moreover, many of these processes require low-pressure and medium-pressure steam which can be generated with a high-temperature heat pump using the waste heat flow from the electrolysis. In hot and remote regions, however, cooling water at the required temperature and in the required quantity is often not available and there is moreover generally a lack of a potential sink for the heat which occurs.

Otherwise, DAC continues to be considered economically unattractive because of the high specific energy requirement per ton of carbon dioxide (CO₂) captured.

### SUMMARY

The invention relates to a combination system comprising a heat pump circuit having a refrigerant evaporator which is designed to evaporate a refrigerant, moreover comprising a compressor which is designed to compress the refrigerant, wherein the compressor is fluidically connected to the refrigerant evaporator, moreover comprising a refrigerant condenser which is designed to condense the refrigerant, wherein the refrigerant condenser is fluidically connected to the compressor, moreover comprising a throttle device which is designed to reduce the temperature and the pressure of the refrigerant, wherein the throttle device is connected to the refrigerant condenser, wherein the refrigerant evaporator is fluidically connected to the throttle device.

The invention moreover relates to a method for operating a combination system, wherein the combination system has a heat pump circuit, wherein a refrigerant is evaporated in a refrigerant evaporator, wherein the evaporated refrigerant is fed to a compressor, wherein the temperature and the pressure of the refrigerant is increased in the compressor, wherein the refrigerant is fed to a refrigerant condenser after the compressor, wherein the refrigerant condenses in the refrigerant condenser, wherein the refrigerant is fed to a throttle device, wherein the temperature and the pressure of the refrigerant is reduced in the throttle device, wherein the refrigerant is fed to the refrigerant evaporator after the throttle device.

The invention generally relates to a cold and heat pump circuit for electrolysis and steam generation for a direct air capture (DAC) process and oxygen under pressure, which can be used to generate electricity, wherein the oxygen has been generated in an electrolyzer.

The object of the invention is to provide a combination system and a method which offers cost advantages.

This object is achieved by a combination system comprising a heat pump circuit having a refrigerant evaporator which is designed to evaporate a refrigerant, moreover comprising a compressor which is designed to compress the refrigerant, wherein the compressor is fluidically connected to the refrigerant evaporator, moreover comprising a refrigerant condenser which is designed to condense the refrigerant, wherein the refrigerant condenser is fluidically connected to the compressor, moreover comprising a throttle device which is designed to reduce the temperature and the pressure of the refrigerant, wherein the throttle device is connected to the refrigerant condenser, wherein the refrigerant evaporator is fluidically connected to the throttle device, moreover comprising a heat generation system having a cooling circuit with a cooling medium, wherein the heat generation system is designed in such a way that the cooling medium can be heated during operation, wherein the cooling medium is fluidically connected to the refrigerant evaporator in such a way that the refrigerant in the refrigerant evaporator can be heated.

The object is also achieved by a method for operating a combination system, wherein the combination system has a heat pump circuit, wherein a refrigerant is evaporated in a refrigerant evaporator, wherein the evaporated refrigerant is fed to a compressor, wherein the temperature and the pressure of the refrigerant is increased in the compressor, wherein the refrigerant is fed to a refrigerant condenser after the compressor, wherein the refrigerant condenses in the refrigerant condenser, wherein the refrigerant is fed to a throttle device, wherein the temperature and the pressure of the refrigerant is reduced in the throttle device, wherein the refrigerant is fed to the refrigerant evaporator after the throttle device, wherein a cooling medium flows in a cooling circuit in a heat generation system, wherein the cooling medium is heated in the heat generation system, wherein the cooling medium is fluidically fed to the refrigerant evaporator in such a way that the refrigerant is heated and the cooling medium is cooled.

It is thus proposed with the invention to use a refrigerant circuit, which can also be referred to as a counterclockwise Brayton cycle, which can be used, on the one hand, as a refrigerant circuit for the electrolysis and, on the other hand, as a high-temperature heat pump for the heating of oxygen and generation of steam.

The basic operating principle of the invention is as described below: after a refrigerant has absorbed the heat from the warm water which leaves the electrolyzer, the refrigerant is evaporated, whilst the water is cooled and fed back to the electrolyzer. It is then compressed in the compressor, which can also be referred to as a refrigerant compressor, to a higher pressure and temperature level. The heat is then used firstly to heat the oxygen under pressure which is created as a by-product during the electrolysis, whilst all of the latent heat is used to generate low-pressure steam in the condenser, which can also be referred to as a refrigerant condenser. The hot oxygen under pressure can then be expanded in an expansion turbine in order to generate electricity and subsequently discharged to the air or transported and used for different purposes (for example, beam generation, oxy-fuel combustion, or oxygen enrichment of the sea) if the transporting distance with the corresponding quantity is reasonable.

The low-pressure steam created in the refrigerant condenser can be used to operate a direct air capture system which requires large quantities of low-pressure steam in order to filter the carbon dioxide (CO₂) from the air. There is no need for an external supply of heat and cold in this configuration because the direct air capture system can be designed precisely to the size of the electrolysis and the heat pump.

The advantages of the system according to the invention and the method according to the invention include, but are not limited to: the use of a refrigerant circuit for cooling the electrolysis and simultaneous heating of oxygen to generate electricity and to generate steam for direct air capture; the low-pressure steam generation in a remote region would meet the need of direct air capture by using the heat of the heat pump; no external pumping of fresh water is necessary; reliable cooling system for the electrolysis in remote and hot regions; the use of the oxygen which occurs as a by-product of the electrolysis to generate electricity; and the generation of negative carbon dioxide (CO₂) emissions by direct air capture.

The already clean and climate-neutral production of green hydrogen becomes even cleaner because it delivers not only a green fuel but also negative carbon dioxide (CO₂) emissions.

The above described properties, features, and advantages of this invention and the manner in which they are achieved will become clearer and more understandable in conjunction with the following description of the exemplary embodiments which will be explained in more detail in conjunction with the drawings.

The same components or components with the same function are here labeled with the same reference signs.

Exemplary embodiments of the invention will be described below on the basis of the drawings. These are not intended to illustrate the exemplary embodiments as true to scale and instead the drawings, which have an explanatory purpose, are executed in a schematic and/or slightly distorted form. With respect to supplements to the teachings which can be seen directly in the drawings, reference is made to the relevant prior art.

### BRIEF DESCRIPTION OF THE DRAWINGS

In the drawings:

FIG. 1 shows a schematic illustration of a combination system according to the invention.

### DETAILED DESCRIPTION

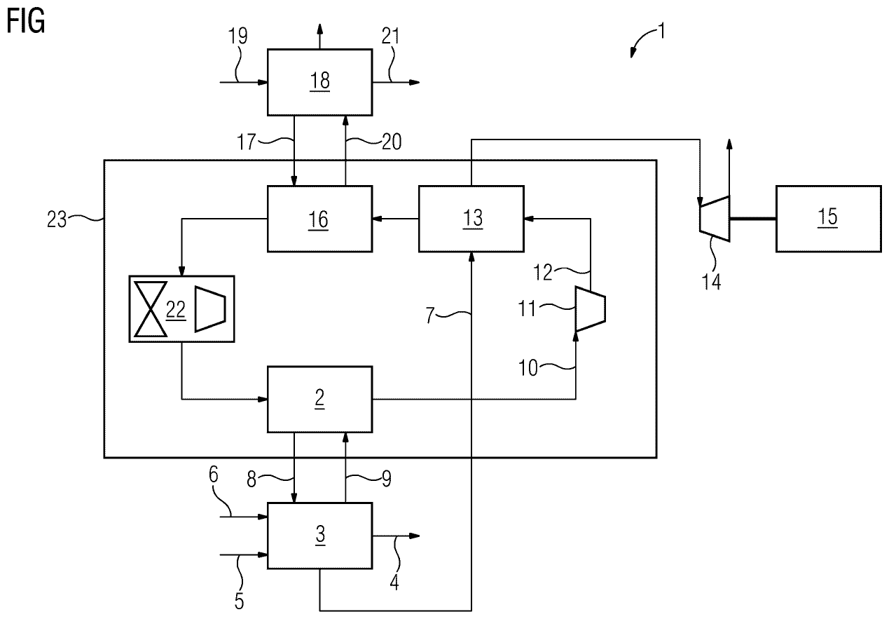

FIG. 1 shows a combination system 1 according to the invention. The combination system 1 comprises a heat pump circuit which will be described below.

A refrigerant which is known in connection with heat pumps is circulated in the combination system 1 in a circuit (counterclockwise in the Figure). The circuit will now be described, beginning with a refrigerant evaporator 2. The refrigerant flows into the refrigerant evaporator 2 and is evaporated there. The heat source required for this process comes from a heat generation system 3.

The heat generation system 3 is an electrolyzer which is designed to generate hydrogen (H₂) and oxygen (O₂) from water with the addition of energy. The added energy can be based on renewable energy generation units such as, for example, solar, wind, or water. The hydrogen (H₂) created is discharged via a line 4. The added water is illustrated symbolically with the line 5. The added energy is illustrated symbolically with the line 6. The oxygen (O₂) created is illustrated symbolically with the line 7.

The heat generation system 3 requires a cooling medium, here water, which is added to the heat generation system 3 via a line 8. Cooled water is thus added to the heat generation system 3, heated there, and returned to the refrigerant evaporator 2 via a further line 9.

The thermal energy of the heated water from the line 9 is used in the refrigerant evaporator 2 to evaporate the refrigerant. The water thus cools and flows back to the heat generation system 3 via the line 8. The refrigerant evaporator 2 can accordingly also be referred to as a cooling system for the cooling medium in the heat generation system 3.

The refrigerant evaporator 2 is thus designed to evaporate the refrigerant. After the refrigerant evaporator 2, the refrigerant flows via a line 10 to a compressor 11. The compressor 11 is designed to compress the refrigerant, wherein the compressor 11 is fluidically connected to the refrigerant evaporator 2 via the line 10.

The temperature and the pressure of the refrigerant are increased in the compressor 11. The heated refrigerant flows via a line 12 through a precooler 13. The oxygen (O₂) generated in the heat generation system 3 also flows through the precooler 13, through the line 7. The thermal energy of the refrigerant is here transmitted in the precooler 13 to the oxygen (O₂), as a result of which the temperature of the oxygen (O₂) increases. The increased thermal energy of the oxygen (O₂) is then converted into mechanical energy in an expander 14, wherein the mechanical energy can then be converted into electrical energy by means of a generator 15.

After it has flowed through the precooler 13, the refrigerant is fed to a refrigerant condenser 16. The refrigerant condenses in the refrigerant condenser 16. The condensate required for the condensation comes from a line 17. The line 17 is fluidically connected to a carbon dioxide system 18, wherein the carbon dioxide system 18 is designed to obtain carbon dioxide (CO₂) 21 directly from the ambient air 19, wherein the steam 20 which can be generated in the refrigerant condenser 16 is fluidically connected to the carbon dioxide system 18.

The combination system 1 moreover comprises a throttle device 22 which is designed to reduce the temperature and the pressure of the refrigerant, wherein the throttle device is connected to the refrigerant condenser 16, wherein the refrigerant evaporator 2 is fluidically connected to the throttle device 22. The throttle device 22 can be a Joule-Thomson valve (JT valve) or an expansion turbine.

The heat pump circuit (illustrated symbolically by the frame 23) is closed again by the return of the refrigerant into the refrigerant evaporator 2.

1. A combination system comprising:
a heat pump circuit having a refrigerant evaporator which is designed to evaporate a refrigerant;
a compressor which is designed to compress the refrigerant, wherein the compressor is fluidically connected to the refrigerant evaporator;
a refrigerant condenser which is designed to condense the refrigerant, wherein the refrigerant condenser is fluidically connected to the compressor;
a throttle device which is designed to reduce a temperature and a pressure of the refrigerant, wherein the throttle device is connected to the refrigerant condenser, wherein the refrigerant evaporator is fluidically connected to the throttle device; and
a heat generation system having a cooling circuit with a cooling medium, wherein the heat generation system is designed in such a way that the cooling medium can be heated during operation, characterized in that the cooling medium is fluidically connected to the refrigerant evaporator in such a way that the refrigerant in the refrigerant evaporator can be heated.

2. The combination system as claimed in claim 1, wherein the refrigerant evaporator is designed in such a way that the cooling medium can be cooled.

3. The combination system as claimed in claim 1, wherein the heat generation system is designed as an electrolyzer.

4. The combination system as claimed in claim 3, wherein the cooling medium is water.

5. The combination system as claimed in claim 3, with a precooler which is fluidically connected to an output of the compressor, wherein the oxygen generated in the electrolyzer is fed to the precooler in such a way that the oxygen can be heated in the precooler.

6. The combination system as claimed in claim 5, further comprising an expander which is fluidically connected to the precooler and is designed in such a way that a thermal energy of the oxygen heated in the precooler can be converted into mechanical energy.

7. The combination system as claimed in claim 6, further comprising a generator which is connected to the expander in a torque-transmitting fashion.

8. The combination system as claimed in claim 7, wherein the refrigerant condenser is fluidically connected to a condensate water line in such a way that water flowing in the condensate water line can be converted into steam in the refrigerant condenser.

9. The combination system as claimed in claim 8, further comprising a carbon dioxide system, wherein the carbon dioxide system is designed to obtain carbon dioxide (CO₂) directly from an ambient air, wherein the steam which can be generated in the refrigerant condenser is fluidically connected to the carbon dioxide system.

10. A method for operating a combination system, wherein the combination system has a heat pump circuit, wherein a refrigerant is evaporated in a refrigerant evaporator, wherein the evaporated refrigerant is fed to a compressor, wherein a temperature and a pressure of the refrigerant is increased in the compressor, wherein the refrigerant is fed to a refrigerant condenser after the compressor, wherein the refrigerant condenses in the refrigerant condenser, wherein the refrigerant is fed to a throttle device, wherein the temperature and the pressure of the refrigerant is reduced in the throttle device, wherein the refrigerant is fed to the refrigerant evaporator after the throttle device, wherein a cooling medium flows in a cooling circuit in a heat generation system, wherein the cooling medium is heated in the heat generation system, characterized in that the cooling medium is fluidically fed to the refrigerant evaporator in such a way that the refrigerant is heated and the cooling medium is cooled.

11. The method as claimed in claim 10, wherein the heat generation system is designed as an electrolyzer and water is used as a cooling medium.

12. The method as claimed in claim 11, wherein a precooler is arranged, through which the refrigerant coming from the compressor flows, wherein oxygen generated in the electrolyzer is fed to the precooler in such a way that a thermal energy of the refrigerant heats the oxygen coming from the electrolyzer.

13. The method as claimed in claim 12, wherein the heated oxygen is fed to an expander which converts the thermal energy of the oxygen into mechanical energy.

14. The method as claimed in claim 13, wherein the refrigerant condenser is designed in such a way that the thermal energy of the refrigerant is used to generate steam.

15. The method as claimed in claim 14, wherein the steam is fed to a carbon dioxide system, wherein the carbon dioxide system is designed to obtain carbon dioxide (CO₂) directly from an ambient air, wherein the steam which can be generated in the refrigerant condenser is fluidically connected to the carbon dioxide system.

16. The method as claimed in claim 15, wherein water created in the carbon dioxide system is fed to the refrigerant condenser, wherein the water is converted into steam in the refrigerant condenser.
